(19) United States
(12) Patent Application Publication
(10) Pub. No.: US 2014/0060867 A1
(43) Pub. Date: Mar. 6, 2014

(54) TOOL BAR EXTENSION FOR AN AGRICULTURAL IMPLEMENT

(71) Applicants: Timothy R. Blunier, Danvers, IL (US); Jessica Haynes, West Bend, WI (US)

(72) Inventors: Timothy R. Blunier, Danvers, IL (US); Jessica Haynes, West Bend, WI (US)

(73) Assignee: CNH America LLC, New Holland, PA (US)

(21) Appl. No.: 13/604,705

(22) Filed: Sep. 6, 2012

(51) Int. Cl. A01B 49/00

(52) U.S. Cl. 172/311

(57) ABSTRACT

An agricultural implement having a tool bar extension. One agricultural implement includes a tool bar assembly having a central tool bar, a first wing tool bar rotatably coupled to a first end of the central tool bar, a second wing tool bar rotatably coupled to the first wing tool bar, a third wing tool bar rotatably coupled to a second end of the central tool bar, and a fourth wing tool bar rotatably coupled to the third wing tool bar. The agricultural implement also includes ground engaging tools. At least a portion of the ground engaging tools is coupled to the tool bar assembly. The agricultural implement includes a tool bar extension rigidly coupled via fasteners to a first distal end of the second wing tool bar, or to a second distal end of the fourth wing tool bar.

### BACKGROUND

The invention relates generally to ground working equipment, such as agricultural equipment, and more specifically, to a tool bar extension for an agricultural implement.

Generally, fertilizer application implements are towed behind a tractor or other work vehicle via a hitch assembly secured to a rigid frame of the implement. These fertilizer application implements typically include one or more ground engaging tools or openers that form a path for fertilizer deposition into the soil. The openers are used to break the soil, thereby enabling injection nozzles (e.g., positioned behind the openers) to deposit fertilizer at a desired depth beneath the soil surface. In certain embodiments, the implement may include knives (e.g., positioned behind the openers), instead of the injection nozzles, to flow the liquid fertilizer into respective trenches formed by the openers and the knives. Using such implements, fertilizer may be distributed throughout a field, either before or after planting, to facilitate enhanced crop development.

A fertilizer application implement generally includes a tool bar for attaching one or more ground engaging tools or openers to the implement. The ground engaging tools are spaced along the tool bar according to the spacing of rows where the fertilizer is to be deposited. Moreover, the number of rows that may receive fertilizer with each pass of the implement is determined by the number of ground engaging tools attached to the tool bar. Accordingly, the number of rows that may receive fertilizer with each pass is limited by the length of the tool bar.

### BRIEF DESCRIPTION

In one embodiment, an agricultural implement includes a tool bar assembly having a central tool bar, a first wing tool bar rotatably coupled to a first end of the central tool bar, a second wing tool bar rotatably coupled to the first wing tool bar, a third wing tool bar rotatably coupled to a second end of the central tool bar, and a fourth wing tool bar rotatably coupled to the third wing tool bar. The agricultural implement also includes ground engaging tools. At least a portion of the ground engaging tools is coupled to the tool bar assembly. The agricultural implement includes a tool bar extension rigidly coupled via fasteners to a first distal end of the second wing tool bar, or to a second distal end of the fourth wing tool bar.

In another embodiment, an agricultural implement includes a tool bar assembly having a tool bar. The agricultural implement also includes ground engaging tools coupled to the tool bar. The agricultural implement includes a first tool bar extension rigidly coupled to a first distal end of the tool bar via fasteners.

In a further embodiment, an agricultural implement includes a tool bar assembly having a tool bar. The agricultural implement also includes a tool bar extension rigidly coupled to a distal end of the tool bar via a plurality of fasteners.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an embodiment of an agricultural implement having a tool bar with tool bar extensions;

FIG. 2 is a front view of the agricultural implement of FIG. 1;

FIG. 3 is a detailed front view of an embodiment of a tool bar extension that may be employed within the agricultural implement of FIG. 1; and

FIG. 4 is an exploded view of the tool bar extension of FIG. 3.

### DETAILED DESCRIPTION

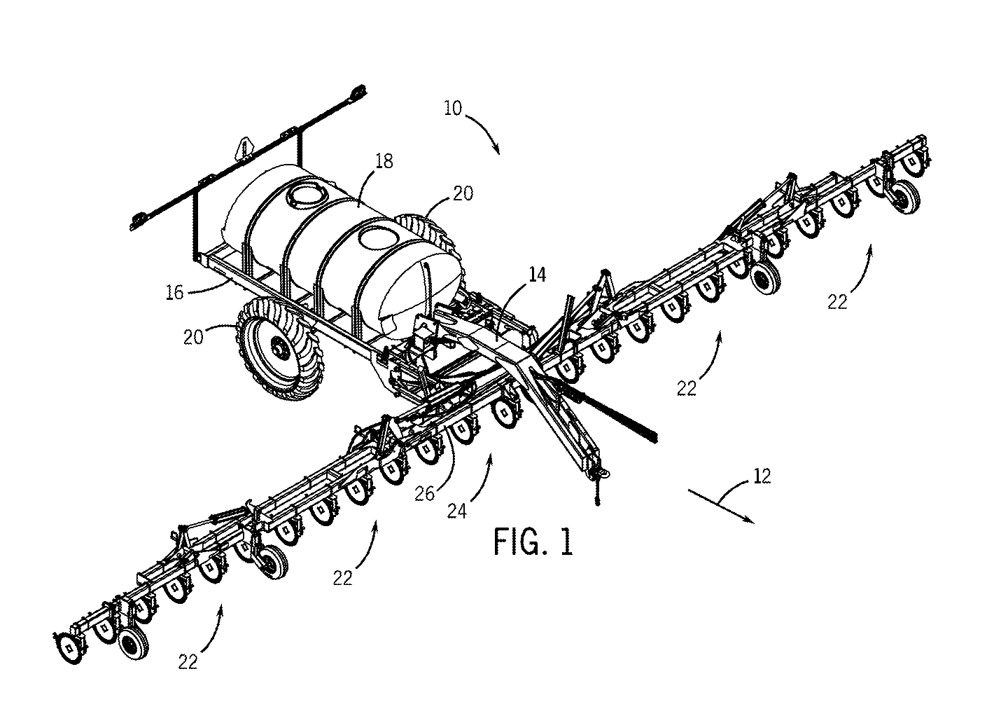

FIG. 1 is a perspective view of an embodiment of an agricultural implement 10 having a tool bar with tool bar extensions. In the illustrated embodiment, the implement 10 is configured to be towed along a direction of travel 12 by a work vehicle, such as a tractor or other prime mover. The work vehicle may be coupled to the implement 10 by a hitch assembly 14, such as the illustrated “goose neck” pull frame. As illustrated, the hitch assembly 14 is coupled to a main frame 16 of the implement 10 to facilitate towing of the implement 10 in the direction of travel 12. In the illustrated embodiment, the main frame 16 supports a storage tank 18 configured to house a flowable agricultural product, such as liquid fertilizer. A pair of wheels 20 coupled to the main frame 16 is configured to support the weight of the frame 16, the storage tank 18, and the flowable agricultural product, thereby enabling the implement 10 to be towed across the field.

The implement 10 is configured to transfer the flowable agricultural product from the storage tank 18 to multiple row units 22 of a tool bar assembly 24 having a tool bar 26. Each row unit 22 includes a ground engaging tool configured to break the soil, thereby excavating a trench into the soil. An injection nozzle or knife (e.g., positioned behind the ground engaging tool) is configured to deposit flowable agricultural product from the storage tank 18 into the trench formed by the ground engaging tool. In certain embodiments, the penetration depth of the ground engaging tools is adjustable to facilitate deposition of the agricultural product at a desired depth beneath the soil surface. Accordingly, a flowable agricultural product, such as liquid fertilizer, may be distributed throughout a field, either before or after planting, to facilitate enhanced crop development.

While the illustrated implement 10 includes 25 row units 22, it should be appreciated that alternative implements may include more or fewer row units 22. In addition, the number of row units and the spacing between row units may be particularly selected to correspond to the arrangement of row units on respective seeding or planting implements. For example, the implement 10 may include 25 row units 22 spaced 30 inches from one another. Accordingly, as the implement 10 is towed across a field, the row units 22 deposit fertilizer in rows having 30-inch spacing. After the fertilizer is applied, a seeding or planting implement (e.g., having row units spaced 30 inches from one another) may deposit seeds between the rows of fertilizer (e.g., the approximate midpoint between rows), thereby facilitating enhanced crop development. In addition, the implement 10 may be utilized to apply fertilizer to previously planted seeds (e.g., via injecting fertilizer between rows of the previously planted seeds).

The tool bar 26 of the tool bar assembly 24 may include tool bar extensions coupled to the distal ends of the tool bar 26. The tool bar extensions may be easily attached and/or removed from the tool bar 26. Further, each tool bar extension may add one or more row units 22 (e.g., with ground engaging tools) to the row units 22 of the tool bar 26. Thus, an agricultural implement 10 having the tool bar extensions may provide flowable agricultural product to a wider swath of soil than an agricultural implement without the tool bar extensions. Accordingly, the agricultural implement 10 may provide flowable agricultural product to a field with increased efficiency.

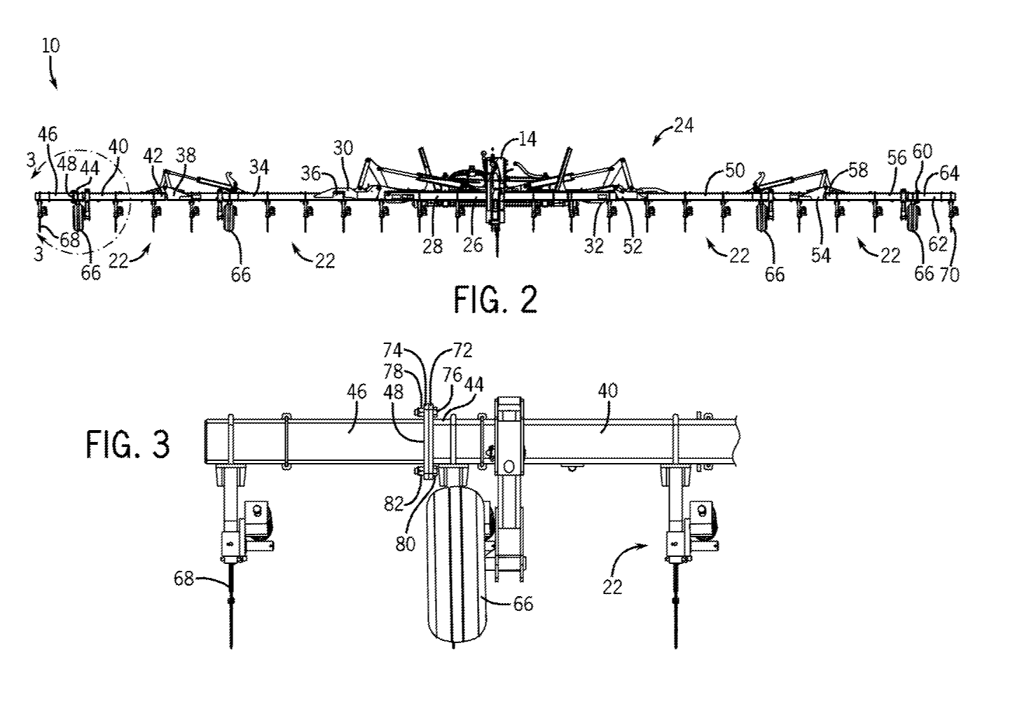

FIG. 2 is a front view of the agricultural implement 10 of FIG. 1. As illustrated, the tool bar 26 includes a central section and four wing sections. Specifically, the tool bar 26 includes a central tool bar 28 having a first end 30 and a second end 32. The first end 30 of the central tool bar 28 is rotatably coupled to a first wing tool bar 34. The first wing tool bar 34 includes a first end 36 and a second end 38. As illustrated, the first end 30 of the central tool bar 28 is rotatably coupled to the first end 36 of the first wing tool bar 34. Moreover, the second end 38 of the first wing tool bar 34 is rotatably coupled to a second wing tool bar 40. The second wing tool bar 40 also includes a first end 42 and a second end 44. The second end 38 of the first wing tool bar 34 is rotatably coupled to the first end 42 of the second wing tool bar 40. The second end 44 of the second wing tool bar 40 is rigidly coupled to a first tool bar extension 46. Specifically, the second end 44 of the second wing tool bar 40 is rigidly and non-rotatably coupled to an end 48 of the first tool bar extension 46.

The second end 32 of the central tool bar 28 is rotatably coupled to a third wing tool bar 50. The third wing tool bar 50 includes a first end 52 and a second end 54. As illustrated, the second end 32 of the central tool bar 28 is rotatably coupled to the first end 52 of the third wing tool bar 50. Moreover, the second end 54 of the third wing tool bar 50 is rotatably coupled to a fourth wing tool bar 56. The fourth wing tool bar 56 also includes a first end 58 and a second end 60. The second end 54 of the third wing tool bar 50 is rotatably coupled to the first end 58 of the fourth wing tool bar 56. The second end 60 of the fourth wing tool bar 56 is rigidly coupled to a second tool bar extension 62. Specifically, the second end 60 of the fourth wing tool bar 56 is rigidly and non-rotatably coupled to an end 64 of the second tool bar extension 62.

While the tool bar 26 of the present embodiment includes five sections, in other embodiments, the tool bar 26 may include any suitable number of sections (e.g., one or more). As may be appreciated, depending on the number of sections of the tool bar 26, any of the ends 30, 32, 38, 44, 54, and 60 of the tool bars may be considered distal ends of the tool bar 26.

As illustrated, wheel assemblies 66 are coupled to the tool bar 26 to facilitate movement of the agricultural implement 10 through a field. Specifically, wheel assemblies 66 are coupled to the first wing tool bar 34, to the second wing tool bar 40, to the third wing tool bar 50, and to the fourth wing tool bar 56. However, wheel assemblies 66 (e.g., wheels) are not coupled to the tool bar extensions 46 and 62. While the tool bar extensions 46 and 62 do not include wheel assemblies 66, each of the tool bar extensions 46 and 62 include one row unit 22. Specifically, the tool bar extension 46 includes a first row unit 68, and the tool bar extension 62 includes a second row unit 70. In certain embodiments, the tool bar extensions 46 and 62 may be configured to add a single row unit 22 to each end of the tool bar 26; however, in other embodiments, the tool bar extensions 46 and 62 may be configured to add multiple row units 22 (e.g., 2, 3, 4, 5, 6, or more) to each end of the tool bar 26.

The tool bar extensions 46 and 62 facilitate easy and rapid extension of the tool bar 26 to add additional row units 22 to the agricultural implement 10. With additional row units 22 as a part of the agricultural implement 10, the duration and/or costs associated with distribution of flowable agricultural product to a field may be reduced. Thus, the tool bar extensions 46 and 62 may be used to more efficiently provide flowable agricultural product to a field. As may be appreciated, the tool bar extensions 46 and 62 are removable. Accordingly, after being installed, the tool bar extensions 46 and 62 may be removed from the tool bar 26. For example, the tool bar extensions 46 and 62 may be removed for operating the agricultural implement 10 in narrower fields, for reducing an amount of flowable agricultural product distributed by the agricultural implement 10, for optimizing an amount of flowable agricultural product distributed, and so forth.

FIG. 3 is a detailed front view of an embodiment of the tool bar extension 46 that may be employed within the agricultural implement of FIG. 1. As illustrated, the second end 44 of the second wing tool bar 40 includes a flange 72 for attaching the tool bar extension 46. Further, the end 48 of the tool bar extension 46 includes a flange 74 configured to be attached to the flange 72. Thus, the tool bar extension 46 may be rigidly and non-rotatably coupled to the second wing tool bar 40 by inserting a first fastener 76 (e.g., bolt, screw, etc.) through an opening in an upper portion of the flange 72 and a corresponding opening in the flange 74, and securing the first fastener 76 using a first locking device 78 (e.g., nut). The bottom portion of the flanges 72 and 74 may also be rigidly and non-rotatably coupled to one another using a second fastener 80 and a second locking device 82. Accordingly, the tool bar extension 46 may be rigidly and non-rotatably coupled to the second wing tool bar 40. As may be appreciated, the first and second fasteners 76 and 80 provide structural support to the tool bar extension 46. It should be noted that more or fewer fasteners 76 and 80 may be used to secure the end 48 of the tool bar extension 46 to the second wing tool bar 40 (e.g., 1, 3, 4, 5, 6, or more). Further, while the tool bar extension 46 is illustrated, the tool bar extension 62 may be coupled to the fourth wing tool bar 56 in a similar manner.

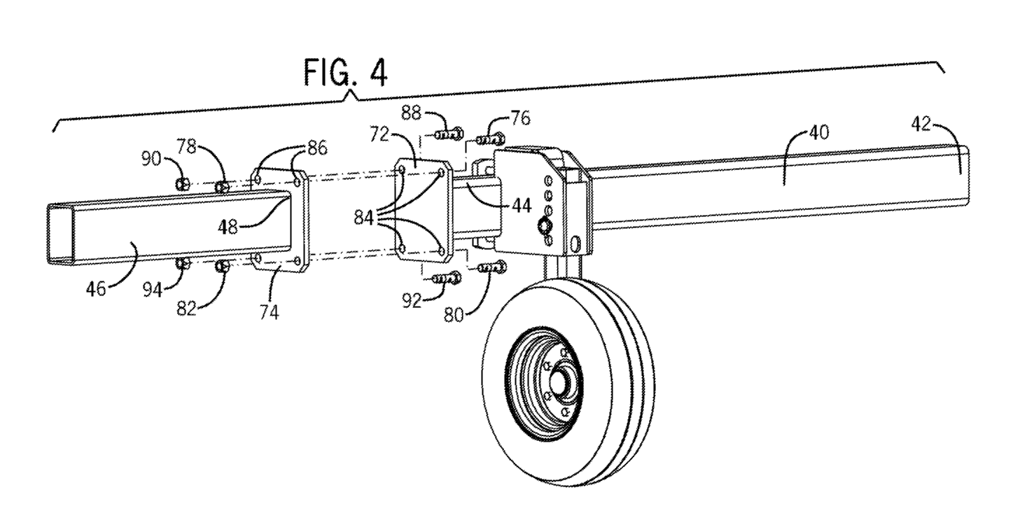

FIG. 4 is an exploded view of the tool bar extension 46 of FIG. 3. As illustrated, the flange 72 includes four openings 84, and the flange 74 includes four corresponding openings 86. Accordingly, the first and second fasteners 76 and 80 may be inserted through the openings 84 and 86. Likewise, a third fastener 88 may be inserted through the openings 84 and 86, and secured by a third locking device 90. In addition, a fourth fastener 92 may be inserted through the openings 84 and 86, and secured by a fourth locking device 94. By using the first, second, third, and fourth fasteners 76, 80, 88, and 92 and their respective locking devices 78, 82, 90, and 94, the tool bar extension 46 may be removably attached to the second wing tool bar 40. Therefore, the tool bar extension 46 may be attached to (e.g., coupled using the fasteners), and/or removed from (e.g., decoupled by removing the fasteners) the second wing tool bar 40 as desired. The tool bar extensions 46 and 62 enable the tool bar 28 to be quickly and easily extended to accommodate additional row units 22. For example, without the tool bar extensions 46 and 62, the agricultural implement 10 may accommodate 23 row units 22. However, by adding the tool bar extensions 46 and 62, the agricultural implement 10 may accommodate 25 row units 22.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An agricultural implement, comprising:
a tool bar assembly comprising a central tool bar, a first wing tool bar rotatably coupled to a first end of the central tool bar, a second wing tool bar rotatably coupled to the first wing tool bar, a third wing tool bar rotatably coupled to a second end of the central tool bar, and a fourth wing tool bar rotatably coupled to the third wing tool bar;
a plurality of ground engaging tools, wherein at least a first ground engaging tool of the plurality of ground engaging tools is coupled to the tool bar assembly;
a tool bar extension rigidly and non-rotatably coupled via a plurality of fasteners to a first distal end of the second wing tool bar, or to a second distal end of the fourth wing tool bar, wherein a second ground engaging tool of the plurality of ground engaging tools is coupled to the tool bar extension, and wherein the first ground engaging tool and the second ground engaging tool are the same type of ground engaging tools;
a first ground engaging wheel coupled to the first distal end of the second wing tool bar and configured to support the second wing tool bar with the tool bar extension coupled thereon; and
a second ground engaging wheel coupled to the second distal end of the fourth wing tool bar and configured to support the fourth wing tool bar with the tool bar extension coupled thereon.

2. (canceled)

3. The agricultural implement of claim 1, wherein the plurality of fasteners comprises a plurality of bolts inserted through openings in the tool bar extension and corresponding openings in the first distal end of the second wing tool bar, or corresponding openings in the second distal end of the fourth wing tool bar.

4. The agricultural implement of claim 1, wherein the tool bar extension is structurally supported by the plurality of fasteners.

5. The agricultural implement of claim 1, wherein the tool bar extension does not have a ground engaging wheel coupled thereon.

6. The agricultural implement of claim 1, wherein the first distal end of the second wing tool bar or the second distal end of the fourth wing tool bar comprises a first flange, the tool bar extension comprises a second flange, and the first flange is rigidly coupled to the second flange by the plurality of fasteners.

7. The agricultural implement of claim 1, wherein only one ground engaging tool of the plurality of ground engaging tools is coupled to the tool bar extension.

8. The agricultural implement of claim 1, wherein the tool bar extension is removably coupled to the first distal end of the second wing tool bar, or to the second distal end of the fourth wing tool bar.

9. The agricultural implement of claim 1, wherein the tool bar extension is configured to have at least one ground engaging tool of the plurality of ground engaging tools attached thereto.

10. An agricultural implement, comprising:
a tool bar assembly comprising a tool bar, wherein the tool bar comprises a wing tool bar rotatable coupled to a central tool bar;
a plurality of ground engaging tools comprising a first ground engaging tool coupled to the tool bar;
a first tool bar extension rigidly and non-rotatable coupled to a first distal end of the wing tool bar via a first plurality of fasteners, wherein a second ground engaging tool of the plurality of ground engaging tools is coupled to the first tool bar extension, and wherein the first ground engaging tool and the second ground engaging tool are the same type of ground engaging tools; and
an actuating cylinder coupled between the wing tool bar and the central tool bar, wherein the actuating cylinder is configured to rotate the wing tool bar relative to the central too bar, and wherein the actuating cylinder is configured to support the wing tool bar with the first tool bar extension coupled to the wing tool bar.

11. (canceled)

12. The agricultural implement of claim 10, wherein the first distal end of the tool bar comprises a first flange, the tool bar extension comprises a second flange, and the first flange of the tool bar is rigidly coupled to the second flange of the tool bar extension by the first plurality of fasteners.

13. (canceled)

14. The agricultural implement of claim 10, wherein the first tool bar extension is configured to have at least one ground engaging tool of the plurality of ground engaging tools attached thereto.

15. The agricultural implement of claim 10, comprising a second tool bar extension rigidly coupled to a second distal end of the tool bar via a second plurality of fasteners.

16. An agricultural implement, comprising:
a tool bar assembly comprising a tool bar, wherein the tool bar comprises a wing tool bar rotatable coupled to a central tool bar;
a tool bar extension rigidly and non-rotatably coupled to a distal end of the wing tool bar via a plurality of fasteners; and
a first ground engaging wheel coupled to the distal end of the wing tool bar and configured to support the wing tool bar with the tool bar extension coupled thereon.

17. The agricultural implement of claim 16, wherein the distal end of the tool bar comprises a first flange, the tool bar extension comprises a second flange, and the first flange of the tool bar is rigidly coupled to the second flange of the tool bar extension by the plurality of fasteners.

18. The agricultural implement of claim 16, wherein the tool bar extension is configured to be decoupled from the tool bar by removing the plurality of fasteners from the tool bar extension, the distal end of the tool bar, or some combination thereof.

19. (canceled)

20. The agricultural implement of claim 16, comprising a ground engaging tool coupled to the tool bar extension.
